(19) United States
(12) Patent Application Publication
(10) Pub. No.: US 2026/0001111 A1
(43) Pub. Date: Jan. 1, 2026

(54) DEVICE AND METHOD FOR THERMAL DEGRADATION OF ORGANIC POLLUTANTS WITH ADDED IONS UNDER CRITICAL TEMPERATURE CONDITIONS

(71) Applicants: Shanghai Institute of Chemical Industry Environmental Engineering Co., Ltd, Shanghai (CN); Shanghai Research Institute of Chemical Industry CO., LTD., Shanghai (CN)

(72) Inventors: Jintao Yu, Shanghai (CN); Shubo Tan, Shanghai (CN); Xiaoyu Ma, Shanghai (CN); Changbo Zhang, Shanghai (CN); Jinze Qian, Shanghai (CN); Xiaoyong Tang, Shanghai (CN); Yuning Xuan, Shanghai (CN); Zhiqiang Liao, Shanghai (CN)

(21) Appl. No.: 19/239,956

(22) Filed: Jun. 17, 2025

(30) Foreign Application Priority Data
Jun. 28, 2024 (CN) 202410859474.5

(51) Int. Cl. B09B 3/40

(52) U.S. Cl. CPC B09B 3/40

(57) ABSTRACT

A device and method for thermal degradation of organic pollutants with added ions under critical temperature conditions are provided. The device includes: a feeding assembly, connected to a critical degradation furnace body; a stirring assembly, a heating assembly and a discharging assembly, disposed on the critical degradation furnace body; an ion electrode generating assembly and an air intake assembly. The ion electrode generating assembly includes a first ion generator disposed on the feeding assembly, a second ion generator disposed in the critical degradation furnace body, a third ion generator disposed on the stirring assembly, and a fourth ion generator disposed on the discharging assembly. The air intake assembly includes an air intake pipe connected to the critical degradation furnace body. The device has advantages of low treatment energy consumption, wide application range, safety and efficiency, and flexible treatment.

### CROSS-REFERENCE TO RELATED APPLICATION

This application claims priority to Chinese Patent Application No. 202410859474.5, filed on Jun. 28, 2024, which is herein incorporated by reference in its entirety.

### TECHNICAL FIELD

The disclosure relates to the field of pollutant treatment technologies, and more particularly to a device and method for thermal degradation of organic pollutants with added ions under critical temperature conditions.

### BACKGROUND

In current organic pollutant treatment technologies, incineration is the most commonly used method. However, the incineration has high system investment cost and operating cost, and cannot be produced in a small scale, so that the incineration is not easy to use in some remote areas or emergency organic pollutant treatment areas. During the incineration process, secondary pollution is easy to be occurred, thereby generating harmful gases and waste residue such as sulfur dioxide, nitrogen dioxide and heavy metals. When the discharge of the harmful gases and waste residue is not treated and controlled well, it will pollute the air and soil. The harmful substances, such as carcinogens and harmful heavy metals, released by the incineration of the organic pollutants are potentially harmful to human health, and may have adverse effects on nearby residents.

In recent years, a degradation method, which can be produced in a small scale, has become more popular and has lower operating cost and investment cost. A mechanism of the degradation method is that organic pollutants are degraded by magnetization of the organic pollutants and reaction with negative oxygen ions under high-temperature conditions. However, this degradation process is a slow degradation process compared to the incineration process, therefore, improving a treatment efficiency of this method will be conducive to promotion and use of this technology.

A Chinese patent application named “a low-temperature magnetized waste degradation furnace with automatic feeding” (a Chinese patent application No. CN201920273401.2, corresponding to a Chinese patent publication No. CN210045743U) provides a device, including a furnace body; a feeding port is defined on an upper end of the furnace body, a smoke exhaust pipe is disposed on an upper part of the furnace body, and a clean treatment device is disposed on an upper part of the smoke exhaust pipe; multiple magnetization units are disposed on a periphery of a lower part of the furnace body, an automatic feeding mechanism is disposed on a side of the furnace body, and the automatic feeding mechanism includes a guide rail, a barrel rack, a feeding power mechanism and a feeding transmission device, an upper end of the guide rail is an arc-shaped structure, and a garbage can is disposed in the barrel rack; and the feeding power mechanism drives the feeding transmission device to convey the barrel rack to the feeding port along the guide rail, and under guidance of the arc-shaped structure at an upper end of the guide rail, the garbage in the garbage can is dumped into the feeding port. The disclosure can convey the garbage to the feeding port without dust, thereby reducing pollution to the environment. However, the device does not solve problems of automatic ignition, automatic slag discharging, uniform feeding, and uniform air intake, which affects the efficiency and process of degradation.

A Chinese patent application named “garbage magnetic cracking device” (a Chinese patent application No. CN201220233930.8, corresponding to a Chinese patent publication No. CN202630071U) discloses a magnetization degradation furnace. Specifically, a magnetization air chamber is disposed at an upper end of a furnace body, the magnetization air chamber is connected to a magnetization machine, and an annular inlet is defined at a lower end of the magnetization air chamber, and is connected to a magnetization cracking layer; and an air duct is disposed vertically in a middle of the furnace body, and is connected to the magnetization air chamber. The device magnetizes the garbage through a super-strong magnetic field, to reduce cohesion between garbage molecules, and reduce heat energy required for garbage cracking, so that the garbage can be cracked at a low temperature, and the discharged gas can fully meet the environmental protection index. This magnetization device has been proved by experiments to be able to magnetize organic matter, and during using the device, it does not require additional energy consumption such as electricity, fuel oil and coal, does not produce harmful substances, and can absorb the smoke produced by low-temperature combustion, and the device is almost zero-pollution. In actual operation, due to a large size of the device, the device has disadvantages of inconvenient garbage loading and easy generation of smoke and dust to pollute the environment during loading. The device still does not solve the problems of automatic ignition, uniform garbage intake and feeding, and automatic slag shedding, and these key problems still plague the degradation efficiency of the technology.

### SUMMARY

An objective of the disclosure is to provide a device and method for thermal degradation of organic pollutants with added ions under critical temperature conditions, to improve degradation efficiency.

The objective of the disclosure can be achieved through the following technical solutions. A device for thermal degradation of organic pollutants with added ions under critical temperature conditions is provided, including a feeding assembly, a critical degradation furnace body (also referred as to a under critical temperature degradation furnace body), a stirring assembly, a heating assembly, a discharging assembly, an ion electrode generating assembly and an air intake assembly. The feeding assembly is connected to the critical degradation furnace body. The stirring assembly, the heating assembly and the discharging assembly are disposed on the critical degradation furnace body. The ion electrode generating assembly includes a first ion generator disposed on the feeding assembly, a second ion generator disposed in the critical degradation furnace body, a third ion generator disposed on the stirring assembly, and a fourth ion generator disposed on the discharging assembly. The air intake assembly includes an air intake pipe connected to the critical degradation furnace body.

In an embodiment, the feeding assembly includes a feeding bin, a feeding hopper, a feeding channel and a conveyer belt. The feeding bin is connected to the critical degradation furnace body through the feeding channel and the feeding hopper in sequence, and the feeding bin is provided with a bin door for opening or closing the feeding bin. The conveyer belt and the first ion generator are disposed in the feeding channel.

In an embodiment, the critical degradation furnace body is provided with a dual-layer furnace wall, and the dual-layer furnace wall comprises an inner wall, an outer wall and a hollow interlayer disposed between the inner wall and the outer wall. The inner wall defines vent holes, and the second ion generator is disposed on the inner wall. A thermal insulation material is disposed on the outer wall, and the air intake pipe is connected to the hollow interlayer between the inner wall and the outer wall.

In an embodiment, the stirring assembly includes a stirring paddle disposed inside the critical degradation furnace body, and a first rotating driving member disposed on an outer side of the critical degradation furnace body. The first rotating driving member is connected to the stirring paddle.

In an embodiment, the stirring paddle is hollow, and defines a vent hole, and the third ion generator is disposed on the stirring paddle. The ion generators and the air duct (i.e., the vent hole) are used to spray ion air. During flowing through the stirring paddle, the air exchanges heat with an inner cavity of the critical degradation furnace body, which can play a preheating role.

In an embodiment, the stirring paddle is a spiral structure, and is configured to uniformly stir the material (i.e., organic pollutant solid waste) horizontally and vertically.

In an embodiment, a cover is detachably mounted on the critical degradation furnace body, the first rotating driving member is disposed on the cover, and a first sealing member is disposed between the first rotating driving member and the cover.

In an embodiment, the cover is connected to the feeding assembly,

In an embodiment, the cover is connected to a tail gas treatment assembly, and the tail gas treatment assembly is configured to treat exhaust gas generated by incomplete combustion.

In an embodiment, the tail gas treatment assembly is a dry tail gas treatment assembly or a wet tail gas treatment assembly.

In an embodiment, the dry tail gas treatment assembly mainly utilizes activated carbon adsorption.

In an embodiment, the wet tail gas treatment assembly mainly utilizes alkaline solution absorption.

In an embodiment, the heating assembly includes an electrode heating rod disposed between the stirring assembly and the discharging assembly.

In an embodiment, the discharging assembly includes a ventilation discharging plate disposed on a bottom of the critical degradation furnace body. The ventilation discharging plate defines vent holes, and the fourth ion generator is disposed on the ventilation discharging plate.

In an embodiment, the ventilation discharging plate is connected to a second rotating driving member.

In an embodiment, the ventilation discharging plate is configured to discharge by cross rotation.

In an embodiment, the second rotating driving member is a rotating motor.

In an embodiment, the device further includes a power supply to supply power to these assemblies.

In an embodiment, multiple temperature measurement assemblies are sequentially arranged along a height direction inside the critical degradation furnace body.

In an embodiment, the multiple temperature measurement assemblies are arranged at intervals along the height direction inside the critical degradation furnace body.

In an embodiment, the critical degradation furnace body defines an observation window.

In an embodiment, a slag outlet is defined on the bottom of the critical degradation furnace body.

In an embodiment, each of the first ion generator, the second ion generator, the third ion generator and the fourth ion generator is a negative ion generator.

In an embodiment, the device further includes a control assembly.

In an embodiment, the control assembly is connected to the feeding assembly, the critical degradation furnace body, the stirring assembly, the heating assembly, the discharging assembly, the ion electrode generating assembly and the air intake assembly.

In an embodiment, the control assembly is configured to control opening and closing of the bin door of the feeding bin, and start and stop of the conveyor belt of the feeding assembly.

In an embodiment, the control assembly is configured to control the first rotating driving member in the stirring assembly.

In an embodiment, the control assembly is configured to control the second rotating driving member in the stirring assembly.

In an embodiment, the control assembly is configured to control the power supply in the ion electrode generating assembly.

In an embodiment, the control assembly is configured to control a valve of the air intake assembly.

In an embodiment, the control assembly is connected to the multiple temperature measurement assemblies and the tail gas treatment assembly.

In an embodiment, the control assembly includes a programmable logic controller (PLC).

A method for thermal degradation of organic pollutants with added ions under critical temperature conditions is provided, which is performed by using the above device, and the method includes:
S1, adjusting an ion air concentration inside the critical degradation furnace body through the air intake assembly and the ion electrode generating assembly, conveying organic pollutant solid waste into the critical degradation furnace body through the feeding assembly, and stirring the organic pollutant solid waste through the stirring assembly;
S2, starting the heating assembly to raise a temperature in the critical degradation furnace body to 500 Celsius degrees (° C.) to 900° C. util a critical self-sustaining reaction is initiated, stopping heating, and introducing ion air into the critical degradation furnace body continuously through the air intake assembly and the ion electrode generating assembly; and
S3, discharging through the discharging assembly.

In an embodiment, a self-sustaining degradation temperature in the critical degradation furnace body is in a range of 300° C. to 450° C.

Critical combustion is a slow, flameless, self-sustaining combustion phenomenon that exists in nature. Organic pollutants with higher calorific value are used as energy sources, and air is introduced into the polluted materials to ignite the pollutants in a low-energy state to cause self-sustaining combustion. Then, combustion heat of the pollutants themselves is used to trigger continuous combustion in surrounding polluted areas, thereby achieving removal of the pollutants. Compared with traditional organic pollutant treatment technologies, an engineered critical combustion technology has advantages of low treatment energy consumption, wide range of applications, safety and high efficiency, flexible treatment, and modular design. The disclosure studies technical conditions for thermal degradation of the organic pollutants in an ion air environment under critical temperature conditions to provide a simple, efficient, and self-sustaining device and method for thermal degradation of organic pollutants with added ions under critical temperature conditions.

Compared with the related art, the disclosure has the following technical effects.
1. The disclosure adopts critical temperature degradation conditions to trigger critical flameless self-sustaining combustion of the organic pollutant solid waste under low energy conditions, and has the advantages of low treatment energy consumption, wide range of applications, safety and high efficiency, and flexible treatment.
2. The disclosure constitutes an integrated automatic operation system with top feeding, middle rotary stirring, bottom automatic discharging, and a self-sustaining reaction mechanism for the organic pollutant solid waste.
3. The disclosure performs uniform mixing and ion ventilation simultaneously. Multiple groups of nozzles (vent holes and the fourth ion generator) with adjustable rotation rates on the inside, the sidewall and the bottom of the critical degradation furnace body distribute the ion air uniformly inside the device to the greatest extent. The middle rotating stirring device uniformly adjusts the organic pollutant solid waste fed into it while introducing ionized air, and at the same time integrates negative ion air, so that the organic pollutant solid waste fed into it is uniformly, orderly and efficiently degraded.
4. An addition of ions in the disclosure can increase activity of oxygen molecules, promote the combustion reaction, thereby improving combustion efficiency and reducing energy waste. Ions can further oxidize and decompose the oxides produced by combustion, reduce emission of harmful gases, and protect the environment and health.
5. The disclosure can solve the problems of automatic ignition, uniform air intake and feeding, and automatic slag shedding, thereby improving the degradation efficiency.
6. The disclosure is simple and efficient, and can realize heat circulation, automatic initiation, self-sustaining operation, and automatic discharging.
7. The disclosure can be applied to the fields of solid waste, hazardous waste, garbage, and oily sludge containing organic pollutants.

### BRIEF DESCRIPTION OF DRAWINGS

FIG. 1 illustrates a schematic structural diagram of a device for thermal degradation of organic pollutants with added ions under critical temperature conditions according to an embodiment of the disclosure.

FIG. 2 illustrates a schematic structural diagram of a feeding assembly of the device for thermal degradation of organic pollutants with added ions under critical temperature conditions according to an embodiment of the disclosure.

FIG. 3 illustrates a schematic structural diagram of a critical degradation furnace body of the device for thermal degradation of organic pollutants with added ions under critical temperature conditions according to an embodiment of the disclosure.

FIG. 4 illustrates a schematic diagram of a thermal insulation material according to an embodiment of the disclosure.

FIG. 5 illustrates a schematic diagram from a top perspective of a discharging assembly of the device for thermal degradation of organic pollutants with added ions under critical temperature conditions according to an embodiment of the disclosure.

### DESCRIPTION OF REFERENCE SIGNS

11—feeding bin; 111—bin door; 12—feeding hopper; 13—feeding channel; 14—conveyor belt; 21—inner wall; 211—vent hole; 22—outer wall; 221—thermal insulation material; 23—hollow interlayer; 24—cover; 25—observation window; 26—slag outlet; 31—stirring paddle; 311—vent hole; 32—first rotating driving member; 33—first sealing member; 41—electrode heating rod; 51—ventilation discharging plate; 511—vent hole; 52—second rotating driving member; 53—second sealing member; 61—first ion generator; 62—second ion generator; 63—third ion generator; 64—fourth ion generator; 71—air intake pipe; 72—vent hole; 8—tail gas treatment assembly; 9—power supply; 10—temperature measurement assembly.

### DETAILED DESCRIPTION OF EMBODIMENTS

The disclosure will be illustrated in detail in conjunction with drawings and embodiments below. The embodiment is implemented based on technical solutions of the disclosure, and provides a detailed implementation method and specific operation process. However, a protection scope of the disclosure is not limited to the following embodiments.

### Embodiment 1

A device for thermal degradation of organic pollutants with added ions under critical temperature conditions is provided, including a feeding assembly, a critical degradation furnace body, a stirring assembly, a heating assembly, a discharging assembly, an ion electrode generating assembly and an air intake assembly.

The feeding assembly is connected to the critical degradation furnace body, and is configured to convey organic pollutant solid waste into the critical degradation furnace body.

The stirring assembly is disposed on the critical degradation furnace body, and including a stirring paddle 31 disposed inside the critical degradation furnace body, and a first rotating driving member 32 configured to drive the stirring paddle 31 to rotate.

The heating assembly includes an electrode heating rod 41 disposed on an inner side of the critical degradation furnace body.

The discharging assembly includes a ventilation discharging plate 51 disposed on a bottom of the inner side of the critical degradation furnace body, and a second rotating driving member 52 configured to drive the ventilation discharging plate 51 to rotate.

The ion electrode generating assembly includes a first ion generator 61 disposed on the feeding assembly, a second ion generator 62 disposed on an inner wall of the critical degradation furnace body, a third ion generator 63 disposed on the stirring assembly, and a fourth ion generator 64 disposed on the discharging assembly.

The air intake assembly includes an air intake pipe 71 and a vent hole 72 connected to the critical degradation furnace body.

### Embodiment 2

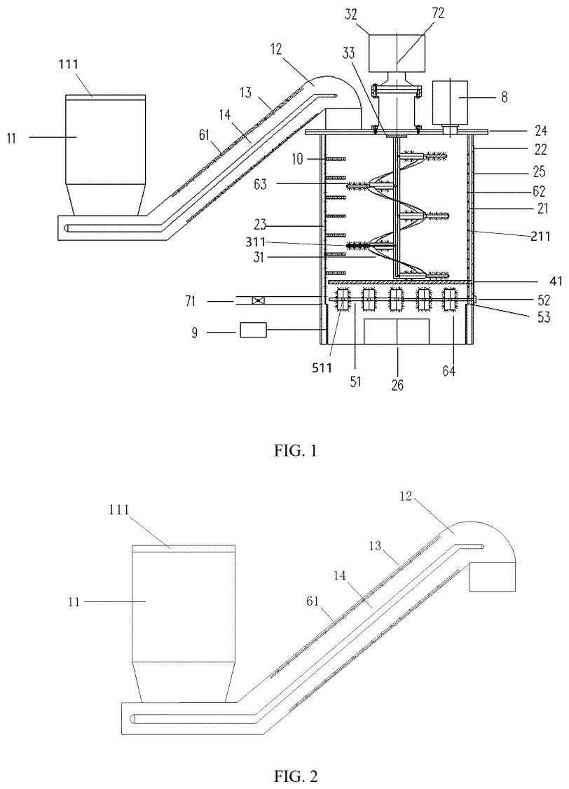

A device for thermal degradation of organic pollutants with added ions under critical temperature conditions is provided, as shown in FIG. 1, the device includes a feeding assembly, a critical degradation furnace body, an ion electrode generating assembly, a rotating motor (i.e., first rotating driving member 32), an outer wall 22 provided with a thermal insulation material 221, a first sealing member 33, a second sealing member 53, a tail gas treatment assembly 8, a cover 24, an inner wall 21 defining vent holes 211 and provided with an electrode material, an air intake assembly, a ventilation discharging plate 51, a slag outlet 26, a power supply 9, an observation window 25, a stirring assembly, a hollow interlayer 23, an electrode heating rod 41 (i.e., heating assembly), and a temperature control and measurement device (i.e., temperature measurement assemblies 10).

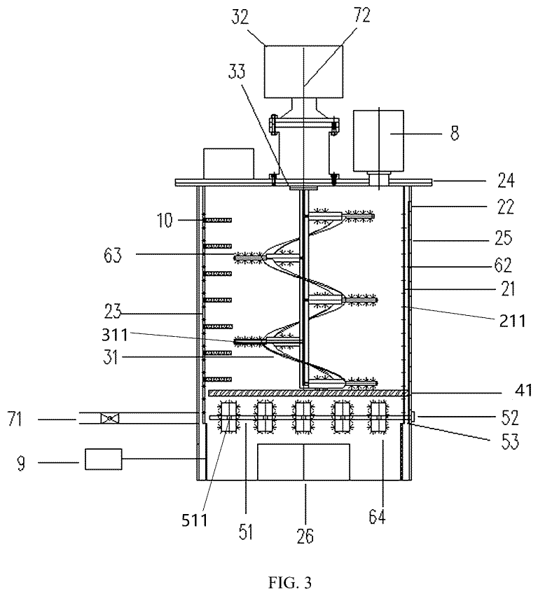

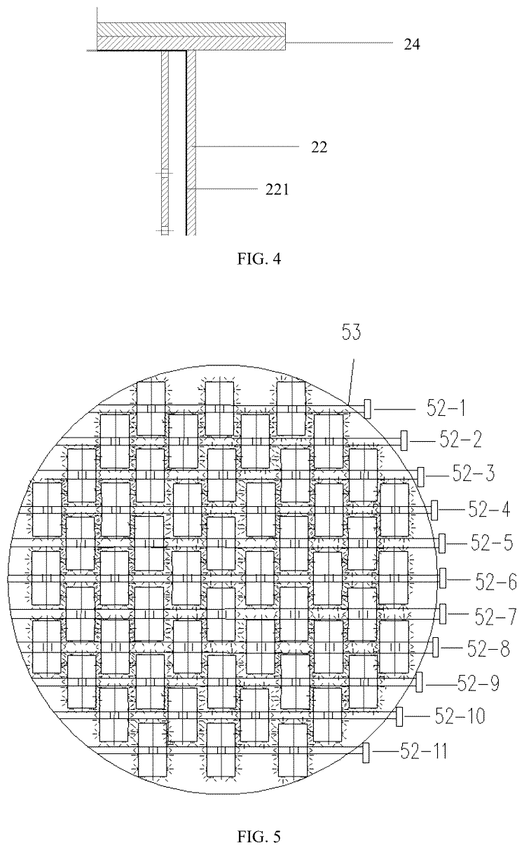

Specifically, as shown in FIG. 2, the feeding assembly is closed storage and conveyance, a feeding bin 11 is a feeding device, and the feeding bin 11 is closed after feeding. During the operating process, a feeding hopper 12 is in a sealing state, to prevent non-ionized air from entering. A first ion generator 61 is disposed in a feeding channel 13 and is configured to ionize air in the feeding bin 11. As shown in FIG. 3, a second ion generator 62 is disposed on the vent holes (211) at the inner wall 21 in the critical degradation furnace body and is configured to ionize air entering the critical degradation furnace body through the hollow interlayer 23 to obtain ionized air. The ionized air passes through the hollow interlayer 23, is preheated on the inner wall 21 of the furnace body (i.e., the critical degradation furnace body), and is uniformly dispersed into the critical degradation furnace body. The outer wall 22 of the furnace body is provided with a thermal insulation material 221. The first rotating driving member 32 drives the stirring paddle 31 to horizontally rotate and mix the feed uniformly. The stirring paddle 31 defines vent holes 311 and a third ion generator 63 is disposed on the stirring paddle 31, and the ionized air is introduced while stirring the feed (i.e., the organic pollutant solid waste) during the operating process. The ion generators are disposed on the vent holes at the stirring paddle 31 and the inner wall 21, which can preheat the air during entering the critical degradation furnace body, and generate the ionized air through the ion generators. The first rotating driving member 32 and the second rotating driving member 52 respectively pass the preheated air through the first sealing member 33 and the second sealing member 53, and then through the third ion generator 63 and the fourth ion generator 64 into the critical degradation furnace body, to avoid air leakage during the rotation process. The tail gas treatment assembly 8 is configured to purify critical degraded air. The cover 24 of the critical degradation furnace body is a detachable cover, which facilitates maintenance and debugging of the furnace body. The air intake assembly includes an electronic control valve, and the electronic control valve is configured to control an air intake amount according to parameter programs such as the feeding amount, a temperature of the critical degradation furnace body and a tail gas detection result.

1.5 tons per hour (t/h) of the feeding amount is taken as an example, and the temperature of the critical degradation furnace body is controlled in a range of 300° C. to 450° C. The tail gas detection result refers to “Integrated Emission Standard of Air Pollutants” (DB32/4041-2021), and the air intake amount is controlled in a range of 0.2 meters per second (m/s) to 2 m/s.

The ventilation discharging plate 51 defines vent holes 511 and a fourth ion generator 64 is disposed on the ventilation discharging plate 51. In an initial stage of operation, the ventilation discharging plate 51 is cross closed to support accumulation of the organic pollutant solid waste. In a middle stage of operation, the program controls the ventilation discharging plate 51 to discharge by cross rotation, and the ventilation discharging plate 51 coordinates with a feeding speed to maintain a self-sustaining continuous operation of the organic pollutant solid waste in the furnace body under critical conditions. The slag outlet 26 is configured to discharge the slag after treatment. The power supply is configured to supply power to the electrodes of the furnace body. The observation window 25 is made of a high-temperature resistant glass, and is configured to observe reaction conditions and extents in the furnace body. The electrode heating rod 41 is configured to control the temperature of the organic pollutant solid waste at the bottom to reach an initiation temperature through the program, which solves the shortcoming that the temperature is too high to exceed the critical condition due to open flame ignition. The temperature measurement assemblies 10 are configured to measure temperatures at different positions of the furnace body, and provide critical reaction progress degree and position data.

Specifically, the feeding hopper 12, the first rotating driving member 32, the first sealing member 33 and the tail gas treatment assembly 8 are mounted on the cover 24 of the furnace body, and the cover 24 is mounted on the critical degradation furnace body. The first ion generator 61 is mounted on an inner wall of the feeding channel 13. The second ion generator 62 is located at the vent holes 211 of the inner wall 21 of the furnace body. The third ion generator 63 is located at the vent holes 311 of the stirring paddle 31 of the stirring assembly. The fourth ion generator 64 is located at the vent holes 511 of the ventilation discharging plate 51. The ion generators are uniformly distributed in various areas of the device, to fully ionize air to form a degradation ion atmosphere and improve degradation efficiency. The thermal insulation material 221 is adhered to an inner side of the outer wall 22 of the furnace body and an inner side of a bottom of the cover 24 of the furnace body.

Specifically, the first ion generator 61, the second ion generator 62, the third ion generator 63 and the fourth ion generator 64 are 220 volts (V) negative ion generators purchased from Dongguan Jingpin Environmental Protection Technology Co., Ltd.

Specifically, the feeding bin 11, the feeding channel 13 and the feeding hopper 12 are closed spaces. The bin door 111 of the feeding bin 11 is closed after feeding, the feed (i.e., the organic pollutant solid waste) is conveyed to the critical degradation furnace body through a track (i.e., the conveyor belt 14), and the first ion generator 61 is disposed on the inner wall of the feeding channel 13 and is configured to ionize air in the feeding assembly.

Specifically, the critical degradation furnace body has a dual-layer furnace wall. The inner wall 21 defines the vent holes 211 and includes electrode materials, the preheated air is ionized through the vent holes 211 and enters the furnace body. The furnace body mixes the ion air fully and uniformly to improve the degradation efficiency. The hollow structure is an air flow channel, and the air is preheated through the inner wall 21 of the furnace body during flow process. The outer wall 22 is provided with the thermal insulation material 221 to prevent thermal and electrical conductivity.

Specifically, the stirring paddle 31 in the furnace body is a hollow stirring paddle, with vent holes 311 containing ion electrodes inside. After the organic pollutant solid waste is fed, it is stirred and mixed uniformly by the stirring paddle 31. During the degradation process, the materials in the furnace body are automatically fed, degraded, and discharged from top to bottom through stirring. The vent holes 311 and ion electrodes in the stirring paddle 31 ionize the preheated air, and the ionized air enters the critical degradation furnace body, to make an ionized air environment inside the furnace body.

Specifically, the bottom of the furnace body is provided with the electrode heating rod 41, which is programmed to heat up to the triggering temperature and then end the heating process (at a rate of 80 Celsius degrees per minute (° C./min) to 100° C./min. After triggering, the organic pollutant solid waste in the furnace body enter a self-sustaining reaction.

Specifically, the bottom of the furnace body is a hollow rotating grate (i.e., the ventilation discharging plate 51), and the vent holes 511 contain ion electrodes. Air is ionized through the vent holes 511 and enters the furnace body. At the initial stage of feeding, the grate is in a horizontal cross state to support the stacking of feeding materials. During the operation process, the grate discharges materials by cross rotation, and runs in a programmed and coordinated manner with the feeding and stirring assemblies, with full automation throughout the process.

Specifically, the side wall of the furnace body defines the observation window 25 and is provided with the temperature measurement assemblies 10. By observing through the observation window 25 and measuring the temperatures at the temperature measurement points, the degree of material degradation and the critical degradation position can be determined, and the feeding, stirring, and discharging speeds can be adjusted.

The above furnace body is used to perform thermal degradation with added ions under critical temperature conditions, which includes the following steps (1)-(4).

### (1) Process Preparation

According to the process requirements, the ventilation discharging plate 51 is in a cross laid state during the feeding period to support the materials (i.e., the organic pollutant solid waste) entering the furnace body. The organic pollutant solid waste is put into the feeding bin 11, and the bin door 111 is closed. The gas source (i.e., the air intake assembly) and the power supply 9 in front of the ion generators are connected to adjust an ion air concentration to 10000 per cubic centimeters (/cm³) to 60000/cm³, and the air intake pressure is adjusted to 0 megapascal (MPa) to 0.5 MPa. The conveyor belt 14 in the feeding bin 11 is started, the first rotating driving member 32 and the stirring paddle 31 convey the organic pollutant solid waste into the critical degradation furnace body for uniform mixing and stacking. The solid waste is stacked at a ⅔ position of the furnace body and the feeding is stopped.

(2) Thermal Degradation with Added Ions Under Critical Temperature Conditions

The electrode heating rod 41 (i.e., the heating assembly) is turned on to raise the temperature to 500° C. to 900° C. until initiating the critical self-sustaining reaction, and then stop heating. A ventilation switch of the air intake assembly and a switch of the power supply 9 of the ion generators are turned on, a certain concentration of ion air is introduced, the thermal degradation reaction under critical temperature conditions proceeds from bottom to top through self-sustaining reaction. By the observation window 25 and the temperature measurement assemblies 10, it is determined that the critical reaction has progressed to the upper part of the furnace body, the feeding assembly and the first rotating driving member 32 are opened, and an air flow rate is controlled by adjusting the air intake assembly. During rotating, the device seals and isolates the interior and external environment of the furnace body through the first sealing member 33 and the second sealing member 53. The rotation speeds of the feeding assembly, the first rotating driving member 32 and the discharge grate (i.e., the ventilation discharging plate 51) are adjusted to achieve the slow movement of solid waste inside the furnace body. The degraded gas inside the device is treated by the tail gas treatment assembly 8 and discharged into the air after meeting the standard. Due to the insulation treatment of thermal insulation materials, the temperature outside the furnace body is relatively low, which will not cause burns to the operators.

### (3) Slag Discharge

The critical reaction is determined to proceed to the upper part of the furnace body through the observation window 25 and the temperature measurement assemblies 10. The second rotating driving member 52 is turned on, and the degraded slag falls off from the furnace body and enters a slag bin. Finally, the slag is taken out through the slag outlet 26. The ventilation discharging plate 51 is in a horizontal flat state at the beginning of the feeding stage, playing a role in supporting the material. As shown in FIG. 4, during the discharging process of the slag, the number and sequence (52-1, 52-2, 52-3, 52-4, 52-5, 52-6, 52-7, 52-8, 52-9, 52-10, and 52-11) of rotating discharges are controlled according to the degree of material operation inside the furnace body. The entire system is a device for thermal degradation with added ions under critical temperature conditions that automatically triggers, operates, and discharges.

### (4) Degradation Effect

It takes 7 hours to continuously degrade 10 tons of the organic pollutant solid waste (water content is 20% to 40%, and ignition loss rate is above 40%) in a furnace, and the generated slag automatically falls to the slag outlet 26 through discharging operation, and the slag is weighed. After this organic pollutant solid waste degradation operation, the weight loss rate is 96%.

In the disclosure, when the air passes through the hollow interlayer of the furnace body, it is preheated by the heat of the inner wall of the furnace body. After passing through the ion electrode generator in the vent holes, it forms ionized air, which is then uniformly introduced into the interior of the furnace body to create an ionized air environment. The electrode heating rod at the bottom of the furnace body is controlled to raise the temperature to reach the critical state before open flame combustion, and then degradation self-sustaining continuous process, thereby achieving the goal of self-sustaining critical treatment of organic solid waste in an ionized environment. The upper feeding device, middle stirring device, and bottom discharging device of the furnace body form a continuous automated operation system.

The above description of the embodiments is for convenience of those skilled in the art to understand and use the disclosure. Those skilled in the art can easily make various modifications to these embodiments and apply general principles described herein to other embodiments without creative labor. Therefore, the disclosure is not limited to the above embodiments, and any improvements and modifications made by those skilled in the art based on the disclosure without departing from a scope of the disclosure should be within the protection scope of the disclosure.

What is claimed is:

1. A device for thermal degradation of organic pollutants with added ions under critical temperature conditions, comprising: a feeding assembly, a critical degradation furnace body, a stirring assembly, a heating assembly, a discharging assembly, an ion electrode generating assembly and an air intake assembly; and
wherein the feeding assembly is connected to the critical degradation furnace body, and the stirring assembly, the heating assembly and the discharging assembly are disposed on the critical degradation furnace body; the ion electrode generating assembly comprises a first ion generator (61) disposed on the feeding assembly, a second ion generator (62) disposed in the critical degradation furnace body, a third ion generator (63) disposed on the stirring assembly, and a fourth ion generator (64) disposed on the discharging assembly; and the air intake assembly comprises an air intake pipe (71) connected to the critical degradation furnace body.

2. The device as claimed in claim 1, wherein the feeding assembly comprises: a feeding bin (11), a feeding hopper (12), a feeding channel (13) and a conveyer belt (14); and
wherein the feeding bin (11) is connected to the critical degradation furnace body through the feeding channel (13) and the feeding hopper (12) in sequence, the feeding bin (11) is provided with a bin door (111) for opening or closing the feeding bin (11), and the conveyer belt (14) and the first ion generator (61) are disposed in the feeding channel (13).

3. The device as claimed in claim 1, wherein the critical degradation furnace body is provided with a dual-layer furnace wall, and the dual-layer furnace wall comprises an inner wall (21), an outer wall (22) and a hollow interlayer (23); the inner wall defines vent holes (211), and the second ion generator (62) is disposed on the inner wall (21); and a thermal insulation material (221) is disposed on the outer wall (22), and the air intake pipe (71) is connected to the hollow interlayer (23) between the inner wall (21) and the outer wall (22).

4. The device as claimed in claim 1, wherein the stirring assembly comprises a stirring paddle (31) disposed inside the critical degradation furnace body, and a first rotating driving member (32) disposed on an outer side of the critical degradation furnace body; and
wherein the first rotating driving member (32) is connected to the stirring paddle (31), the stirring paddle (31) is hollow, and defines vent holes (311), and the third ion generator (63) is disposed on the stirring paddle (31).

5. The device as claimed in claim 4, wherein a cover (24) is detachably mounted on the critical degradation furnace body, the first rotating driving member (32) is disposed on the cover (24), a first sealing member (33) is disposed between the first rotating driving member (32) and the cover (24), the cover (24) is connected to the feeding assembly, and the cover (24) is connected to a tail gas treatment assembly (8).

6. The device as claimed in claim 1, wherein the heating assembly comprises an electrode heating rod (41) disposed between the stirring assembly and the discharging assembly.

7. The device as claimed in claim 1, wherein the discharging assembly comprises a ventilation discharging plate (51) disposed on a bottom of the critical degradation furnace body; and
wherein the ventilation discharging plate (51) defines vent holes (511), and the fourth ion generator (64) is disposed on the ventilation discharging plate (51).

8. The device as claimed in claim 7, wherein the ventilation discharging plate (51) is connected to a second rotating driving member (52), and the ventilation discharging plate (51) is configured to discharge by cross rotation.

9. The device as claimed in claim 1, further comprising a power supply (9), and a plurality of temperature measurement assemblies (10) sequentially arranged along a height direction of the critical degradation furnace body, wherein the critical degradation furnace body defines an observation window (25) and a slag outlet (26).

10. A method for thermal degradation of organic pollutants with added ions under critical temperature conditions, performed by using the device as claimed in claim 1, comprising:
S1, adjusting an ion air concentration inside the critical degradation furnace body through the air intake assembly and the ion electrode generating assembly, conveying organic pollutant solid waste into the critical degradation furnace body through the feeding assembly, and stirring the organic pollutant solid waste through the stirring assembly;
S2, starting the heating assembly to raise a temperature in the critical degradation furnace body to 500° C. to 900° C. util a critical self-sustaining reaction is initiated, stopping heating, and introducing ion air into the critical degradation furnace body continuously through the air intake assembly and the ion electrode generating assembly; and
S3, discharging through the discharging assembly.
